(19) United States
(12) Patent Application Publication
(10) Pub. No.: US 2026/0364533 A1
(43) Pub. Date: Nov. 19, 2026

(54) DEVICE FOR THE AFTERTREATMENT OF EXHAUST GASES

(71) Applicant: EMITEC TECHNOLOGIES GMBH, Lohmar (DE)

(72) Inventors: Peter HIRTH, Lohmar (DE); Sebastian DUNG, Lohmar (DE)

(21) Appl. No.: 19/133,841

(22) PCT Filed: Nov. 24, 2023
(86) PCT No.: PCT/EP2023/082927

§ 371 Date: May 29, 2025

(30) Foreign Application Priority Data
Nov. 29, 2022 (DE) 10 2022 212 756.0

(51) Int. Cl. B01D 53/94; B01J 35/57

(52) U.S. Cl. CPC B01D 53/94; B01J 35/57; B01D 2258/01

(57) ABSTRACT

A device for the aftertreatment of exhaust gases of an internal combustion engine contains a metal matrix through which a fluid can flow along a main flow direction. The matrix is made of a plurality of metal foils which are stacked one on top of the other in order to form a layer stack and which are wound in order to form the matrix. A plurality of flow channels are formed between the metal foils, and the matrix is received in a casing tube. An inner tube is arranged between the matrix and the casing tube, and the inner tube has a structured part, whereby the inner tube is configured to contact the matrix and/or the casing tube only in some sections.

The invention relates to a device for the aftertreatment of exhaust gases from an internal combustion engine, with a metallic matrix through which a flow can pass along a main flow direction, wherein the matrix is formed by a plurality of metal foils which are stacked on top of one another to form a layer stack and are wound or twisted to form the matrix, wherein a plurality of flow channels are formed between the metal foils and wherein the matrix is accommodated in a casing tube.

Honeycomb bodies for catalytic converters for exhaust gas aftertreatment of internal combustion engines have a plurality of flow channels through which a flow can pass along a main flow direction. Honeycomb bodies, in particular honeycomb bodies made of metal, can be formed by a large number of smooth and/or at least partially structured metal foils which are stacked on top of each other and wound or (at least partially) twisted to form the final honeycomb body. The matrix (honeycomb body) formed from the metal foils is inserted into a housing for stabilization and, in particular, for protection against mechanical disturbances, and is permanently connected to the housing.

In the simplest case, the housing is formed by a tube which is designed to accommodate the matrix inside it. A further function of the housing is to ensure the flow of gas through the honeycomb body and, in particular, to prevent exhaust gas from bypassing the honeycomb body.

The matrix must be permanently secured in the housing, which is why brazed joints are regularly created between the matrix and the casing.

A particular disadvantage of the devices in the prior art is that the matrix rests against the entire surface of the casing and is connected to it by brazed joints, which means that the matrix cannot move flexibly in the radial and axial directions. Even partial connections between the matrix and the casing are disadvantageous, as braze material can be carried over when the matrix is pressed into the casing and, during the brazing process, the capillary forces between the casing and the matrix can cause the brazing material to flow into undesirable areas. Furthermore, the essentially full-surface abutment of the matrix with the casing does not create a thermally insulating connection, resulting in increased thermal mass in the edge area of the matrix and thus increased heat transfer to the environment via the casing.

Therefore, the object of the present invention is to solve at least some of the problems described with reference to the prior art and, in particular, to create a matrix accommodated in a casing which allows flexible movement of the matrix to compensate for thermally induced forces and/or can reduce heat transfer from the matrix to the casing.

The object with regard to the device is achieved by a device having the features of claim 1. Advantageous further embodiments are specified in the dependent claims. The features listed individually in the claims can be combined with each other and/or with features of the description in any manner. The description, in particular in connection with the figures, explains the invention and specifies additional embodiments.

This is aided by a device for the aftertreatment of exhaust gases from an internal combustion engine, which has a metallic matrix through which a flow can pass along a main flow direction, wherein the matrix is formed by a plurality of metal foils which are stacked on top of one another to form a layer stack and are wound or coiled (e.g., at least partially twisted) to form the matrix. Flow channels (in particular a multiplicity of flow channels) are formed between the metal foils, wherein the matrix is accommodated in a casing tube. An inner tube is arranged between the matrix and the casing tube, wherein the inner tube has a structuring whereby the contact between the inner tube and the matrix and/or the casing tube is only formed in sections.

Honeycomb bodies or matrices of this type are already known in many forms. The matrix is formed from a plurality of metal foils, at least some of which are at least partially structured. The metal foils are stacked on top of each other. A layer stack formed in this way is wound, coiled or twisted around at least one pivot point. This creates cells between the individual metal foils, which can be flowed through along a main flow direction that runs along the axial extension of the matrix. Depending on the intended use, the metal foils can be provided with a catalytically active coating comprising a so-called washcoat, which may carry catalytically active material for converting pollutants in the exhaust gas, so that the media (exhaust gases) flowing along the formed flow channels can be chemically converted, for example, on the surface of the matrix.

The matrix produced from the metal foils is inherently unstable and is inserted into a so-called casing tube to protect it from mechanical damage. This casing tube often also serves to conduct the exhaust gas and forms the exhaust gas passage through which the exhaust gas can flow.

Here, it is proposed that the matrix is accommodated in an inner tube and the matrix accommodated in the inner tube is finally inserted into the casing tube. The inner tube, which is formed in particular with a metal foil, is structured so that the matrix with its radially outwardly directed surface and/or the casing tube with its radially inwardly directed surface rests against the structures of the inner tube that extend from the cylindrical base surface.

The inner tube can be a separate component. The structuring can be formed with a plurality of structures, in particular of the same type, adjacent to one another or spaced apart from one another. The inner tube can be provided with structures on (almost) its entire inwardly and/or outwardly directed surface, so that the inner tube is designed with the structuring over a large area or predominantly. The structuring may comprise protrusions and/or recesses in the radial direction or toward the casing tube and/or the matrix. The protrusions and/or recesses may be alternately arranged in the axial direction and/or circumferential direction of the inner tube. In particular, only recesses and protrusions are provided in the area of the structuring of the inner tube, so that, for example, only smooth, possibly cylindrical, inner tube edge sections are formed outside this area.

The contact between the inner tube and the matrix and/or the casing tube is only formed in sections, with a small contact area being formed relative to the entire surface of the inner tube. The contact surface can be (essentially) linear, with the contact lines preferably running at least partially (or predominantly) in the circumferential direction and/or at an angle of less than 90° to the circumferential direction. The section in which contact is present can be less than 20%, in particular less than 10%, of the outer or inner surface of the inner tube.

It is particularly advantageous if the inner tube has a lower material thickness than the casing tube. The inner tube is also formed from a thin metal foil, preferably the metal foil has a thickness of 0.01 mm and 2.0 mm [millimeters], preferably between 0.05 mm and 0.5 mm, particularly preferably between 0.08 mm and 0.3 mm. In particular, compared to the casing tube, the material thickness of the inner tube can be very low, so that the casing tube has a casing tube thickness that is at least twice, in particular at least ten times, greater than the selected material thickness of the inner tube.

The inner tube may have protrusions and recesses which protrude in the radial direction from the main casing surface of the inner tube or are recessed in this direction.

The metal foil which preferably forms the inner tube is structured. This means that the metal foil has protrusions and recesses which protrude from the cylindrical basic shape formed by a smooth metal foil or from the main casing surface formed by the cylinder. Hexagonal structures are preferably embossed into the metal foil in cross-section. Such a hexagonal structure may comprise a hexagonally protruding/recessing frame and a recessing/protruding bulge enclosed therein. Alternatively, the individual structures may also have different cross-sections.

The protrusions and recesses extending from the base surface form the contact surfaces or contact lines, or even just contact points, at which the casing tube rests on one side and the outer surface of the matrix rests on the other side.

The contact between the inner tube and the matrix and/or the casing tube can only be formed in the area of the protrusions and/or recesses.

This is advantageous because the contact surface between the inner tube and the casing tube or the matrix is significantly smaller than in a full-surface abutment, as is the case in honeycomb bodies or matrices known from the prior art.

This reduces the heat transfer from the matrix to the casing tube, thereby reducing heat losses. Due to the contact points or contact surfaces defined by the structures, a very defined connection of the matrix to the inner tube and of the inner tube to the casing tube is ensured. This prevents brazing material carryover or capillary action between the matrix and the inner tube and/or between the inner tube and the casing tube, which could cause brazing material displacement.

Air-filled chambers can be formed between the matrix and/or the casing tube (on the one hand) and the inner tube (on the other hand), through which the respective components are spaced apart from each other in some areas.

The air-filled chambers are created by the protrusions and recesses. The air-filled chambers can be separated or delimited from one another by the protrusions and recesses. At structural maxima of the inner tube, there is abutment with the casing tube on one side and abutment with the outer surface of the matrix on the other side. In the remaining area of the respective structuring, an air chamber is formed between the inner tube and the casing tube or between the inner tube and the matrix. The air-filled chambers can form thermal insulation or a barrier with respect to these components.

The contact area between the inner tube and the casing tube and between the inner tube and the matrix can be significantly smaller than with a matrix of the same size lying flat against the casing tube. This is achieved by the reduced abutment area resulting from the structuring. The reduced abutment surface ensures lower heat conduction from the flowing exhaust gas via the matrix to the casing tube, which reduces heat losses and thus improves the efficiency of the exhaust gas aftertreatment device. The matrix also heats up more quickly, which is beneficial for rapidly reaching the required operating temperature, known as the light-off temperature.

Furthermore, it may be provided that the casing tube has at least two sections with different inner diameters, wherein the contact surfaces between the inner tube and the casing tube are formed in the region of the section with the smaller inner diameter. A stepped casing tube with sections of different inner diameters allows an air gap to be created at least in sections, which runs around the circumference and provides (additional) thermal insulation. The casing tube preferably lies against the inner tube in the section with the smallest inner diameter. The sections with the larger diameter do not lie against the inner tube.

The casing tube can be designed as a single piece or (alternatively) as multiple pieces.

It may also be useful to arrange at least one sealing element between the casing tube and the inner tube, which creates a seal at least in the axial direction of the device. The sealing element can, for example, be formed by (at least) one sealing ring or with (at least) one sealing ring, which is arranged between the inner tube and the casing tube. The sealing ring, which must be temperature-stable, prevents the exhaust gas from flowing into the air gap formed between the casing tube and the inner tube.

In addition, it may be advantageous if the sealing element is produced by reforming the inner tube and/or the casing tube.

Alternatively, the seal in the axial direction can also be produced by selectively forming the casing tube and/or the inner tube. For this purpose, for example, an axial end of the casing tube or the inner tube can be bent so that (only) in this axial end section there is a flat abutment between the casing tube and the inner tube.

Furthermore, it may be advantageous if the casing tube is designed in multiple parts, wherein the casing tube is formed from multiple tube sections which have different inner diameters.

The invention and its context are explained in detail below with reference to the schematic drawings and examples of embodiments. It should be noted that elements designated by the same reference signs in the drawings may have the same properties, unless explicitly stated otherwise here. The elements illustrated in the drawings may be further characterized by features from other drawings and/or the description and/or the claims (and vice versa), unless explicitly excluded below. The drawings show:

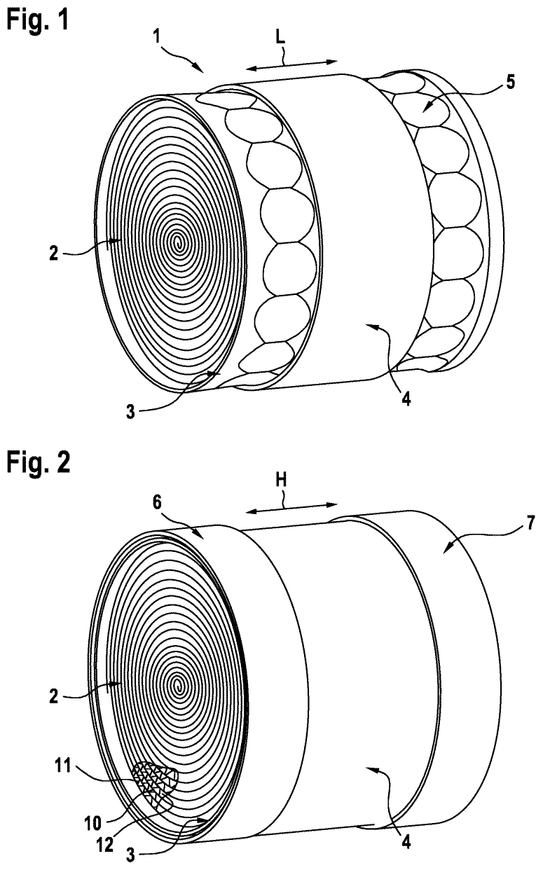

FIG. 1 a perspective view of a device with a structured inner tube and a casing tube extending in the axial direction over part of the inner tube,

FIG. 2 a perspective view of a device according to FIG. 1, wherein two further sections of the casing tube are arranged around the inner tube, and

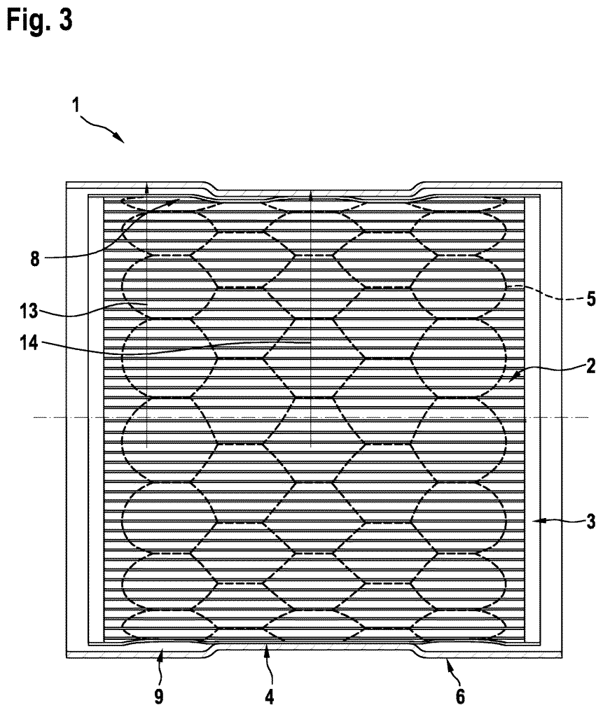

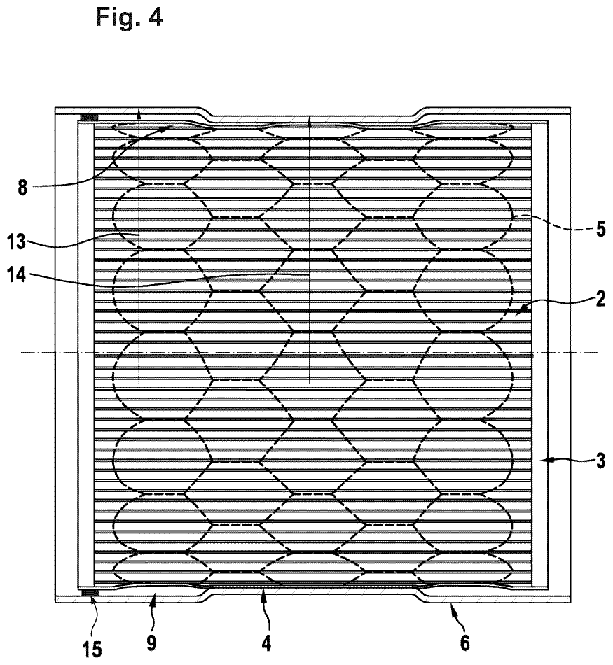

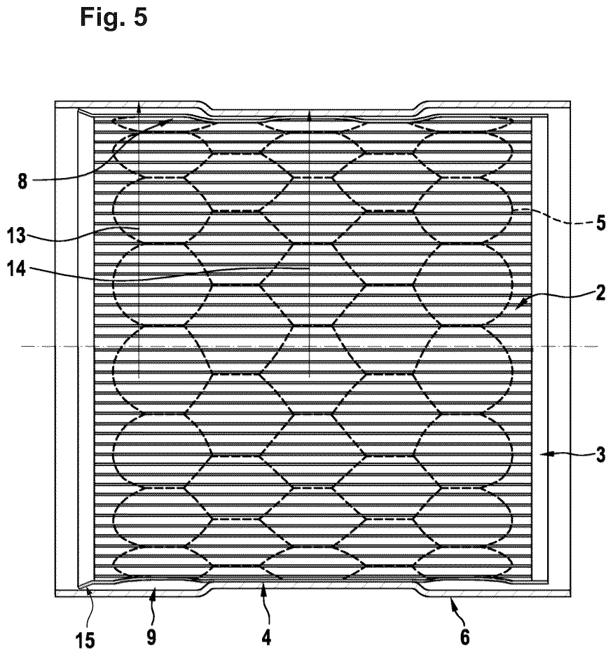

FIG. 3 a sectional view through a device with a matrix, an inner tube and a casing tube with sections of different inner diameters.

FIG. 1 shows a device 1 which is formed by a through-flowable matrix 2, an inner tube 3 and a casing tube 4.

The casing tube 4 is only partially shown. In particular, the axial length L of the casing tube 4 corresponds to the axial length of the matrix 2 and the inner tube 3.

In particular, a section of the casing tube 4 is shown which rests against the structures 5 formed in the inner tube 3 and is in contact with the inner tube 3 in the region of the structure maxima of the structures which extend towards the casing tube 4. The structures 5 of the inner tube 3 have a hexagonal cross-section and are alternately extended in the direction of the matrix 2 and the casing tube 4.

FIG. 2 shows a device 1 as already shown in FIG. 1. In addition to the casing tube 4, further subsections 6, 7 of the casing tube 4 are shown to the right and left of this casing tube 4. These subsections 6, 7 have a larger inner diameter than the central casing tube 4 and are therefore not in contact with the structures 5 of the inner tube 3. An air gap extending in the circumferential direction is formed between the subsections 6, 7 and the inner tube 3.

A schematic section shows that the matrix 2 is formed by smooth metal foils 12 and structured metal foils 11 arranged in alternating layers, which form a plurality of flow channels 13. The flow channels 13 run parallel to the main flow direction H.

FIG. 3 shows a sectional view through the device 1 as already shown in FIG. 2. The section shows the matrix 2, the structured inner tube 3 and the casing tube 4 formed in sections of different diameters (first (inner) diameter 14 and second (inner) diameter 15). The central section of the casing tube 4 has a smaller diameter than the subsections 6, 7 and is in abutment with the structured inner tube 3. It can be clearly seen that contact surfaces with the casing tube 4 are only formed at the extended structural maxima of the inner tube 3. An air gap 9 extending in the circumferential direction is formed between the subsections 6, 7 and the inner tube 3, which provides thermal insulation in addition to the air chambers 8.

The embodiments shown in FIGS. 1 to 3 are not intended to be limiting and serve only to illustrate the concept of the invention.

### LIST OF REFERENCE SYMBOLS

1 Device
2 Matrix
3 Inner tube
4 Casing tube
5 Structures
6 Subsection of the casing tube
7 Subsection of the casing tube
8 Air chamber
9 Air gap
10 Smooth metal foil
11 Structured metal foil
12 Flow channel
13 First diameter
14 Second diameter
L Axial length
H Main flow direction

1-9. (canceled)

10. A device for an aftertreatment of exhaust gases from an internal combustion engine, the device comprising:
a casing tube;
a metallic matrix through which a flow can pass along a main flow direction, said metallic matrix formed from a plurality of metal foils being stacked on top of one another to form a layer stack and being wound to form said metallic matrix, wherein a plurality of flow channels are formed between said metal foils, wherein said metal matrix is accommodated in said casing tube; and
an inner tube disposed between said metal matrix and said casing tube, wherein said inner tube has a structuring whereby contact between said inner tube and said metallic matrix and/or said casing tube is only formed in sections.

11. The device according to claim 10, wherein said inner tube has a lower material thickness than said casing tube.

12. The device according to claim 10, wherein said inner tube has protrusions and recesses formed therein which form in a radial direction from a main surface of said inner tube.

13. The device according to claim 12, wherein said contact between said inner tube and said metallic matrix and/or said casing tube is only formed in a region of said protrusions and/or said recesses.

14. The device according to claim 10, further comprising air-filled chambers formed between said metallic matrix and/or said casing tube and said inner tube, through which respective components are spaced apart from each other in some areas.

15. The device according to claim 10, wherein said casing tube has at least two sections with different inner diameters, wherein contact surfaces between said inner tube and said casing tube are formed in a region of a section of said at least two sections with a smaller inner diameter.

16. The device according to claim 15, further comprising at least one sealing element disposed between said casing tube and said inner tube, said at least one sealing element creating a seal at least in an axial direction of the device.

17. The device according to claim 16, wherein said at least one sealing element is produced by reshaping said inner tube and/or said casing tube.

18. The device according to claim 10, wherein said casing tube is configured in multiple parts, wherein said casing tube is formed from multiple tube sections which have different inner diameters.
